(19) United States
(12) Patent Application Publication
(10) Pub. No.: US 2011/0228061 A1
(43) Pub. Date: Sep. 22, 2011

(54) SYNCHRONIZING OF THREE-DIMENSIONAL EYEWEAR

(75) Inventor: William Pat Price, Keller, TX (US)

(73) Assignee: VIZIO INC., Irvine, CA (US)

(21) Appl. No.: 12/727,766

(22) Filed: Mar. 19, 2010

(51) Int. Cl. H04N 13/04

(52) U.S. Cl. 348/56; 348/E13.075

(57) ABSTRACT

An application for three-dimensional eyewear that includes a left-eye shutter and a right-eye shutter. The shutters open and close in unison with a display of left-eye content and right-eye content. Because the shutters do not instantaneously open and close, a delay is inserted into the opening of each of the shutters until the other shutter has had enough time to have at least partially closed.

### CROSS-REFERENCE TO RELATED APPLICATION

This application is related to U.S. patent application Ser. No. 12/697,310, titled “PIXEL SYSTEM, METHOD AND APPARATUS FOR SYNCHRONIZING THREE-DIMENSIONAL EYEWEAR,” attorney docket 10.0000, U.S. patent application Ser. No. 12/697,312, titled “FRAME SYSTEM, METHOD AND APPARATUS FOR SYNCHRONIZING THREE-DIMENSIONAL EYEWEAR,” attorney docket 10.0002, U.S. patent application Ser. No. 12/697,313, titled “PIXEL BASED THREE-DIMENSIONAL ENCODING METHOD,” attorney docket 10.0003 and U.S. patent application Ser. No. 12/697,315, titled “FRAME BASED THREE-DIMENSIONAL ENCODING METHOD,” attorney docket 10.0004 all of which were filed on Feb. 1, 2010.

### FIELD

This invention relates to the field of display devices worn over an individual's eyes and more particularly to a system for reducing artifacts and eye strain caused by synchronizing the display devices with content presented on a display screen.

### BACKGROUND

There are several ways to present a three-dimensional image to a viewer of a television. The common aspect of the existing methods is to present an image or frame from two perspectives, a left-eye perspective of the content to the left eye and present an image or frame from a right-eye perspective to the right eye. This creates the proper parallax so that the viewer sees both perspectives and interprets what they are seeing as three-dimensional.

Early three-dimensional content was captured using two separate cameras aimed at the subject but slightly separate from each other providing two different perspectives. This simulates what the left eye and right eye see. The cameras simultaneously exposed two films. Using three-dimensional eyewear, the viewer looks through one film with the left eye and the other film with the right eye, thereby seeing what looks like a three-dimensional image.

Progressing to motion pictures, three-dimensional movies were produced in a similar way with two cameras, but the resulting images were color encoded into the final film. To watch the film in three-dimension, eyewear with colored filters in either eye separate the appropriate images by canceling out the filter color. This process is capable of presenting a three-dimensional movie simultaneously to a large audience, but has marginal quality and, because several colors are filtered from the content, results in poor color quality, similar to a black and white movie.

More recently, personal headsets have been made that have two separate miniature displays, one for each eye. In such, left content is presented on the display viewed by the left eye and right content is presented on the display viewed by the right eye. Such systems work well, but require a complete display system for each viewer.

Similar to this, Eclipse methods uses a common display, such as a television, along with personal eyewear that have fast-response shutters over each eye. In such, the left-eye shutter is open allowing light to pass, the right-eye shutter is closed blocking light and the television displays left-eye content, therefore permitting the light (image) from the television to reach the left eye. This is alternated with closing of the left-eye shutter, opening of the right-eye shutter and displaying right-eye content the television. By alternating faster than the typical human response time, the display appears continuous and flicker-free.

Irrespective of how the synchronization signal reaches the three-dimensional eyewear, the three-dimensional eyewear must open one eye shutter and close the other eye shutter during each transition of the synchronization signal. For example, at the leading edge of the synchronization signal, the left-eye shutter closes and the right-eye shutter opens. In an ideal world, the opening and closing occur instantaneously, but in the real world, the liquid crystal shutters take a short amount of time to change from open to close and visa versa. During this short amount of time, the open shutter gradually closes and the closed shutter gradually opens, creating a short time when both shutters are partially open. This short period of time is not detectable by the wearer of the eyewear, but subliminally, the wearer's brain starts to decode what is being viewed until the proper shutter finally opens and the other shutter closes. This partial view time often leads to headaches, fatigue and other symptoms when watching three-dimensional content for extended periods of time.

What is needed is a three-dimensional eyewear system that reduces crosstalk by shutters, thereby reducing fatigue.

### SUMMARY

Three-dimensional eyewear has a left-eye shutter and a right-eye shutter. The shutters open and close in unison with a display of left-eye content and right-eye content, respectively. Because the shutters do not instantaneously open and close, a delay is inserted into the opening of each of the shutters until the other shutter has had enough time to have at least partially closed.

In one embodiment, a three-dimensional eyewear synchronization system is disclosed. The three-dimensional eyewear includes a display that alternately displays left-eye content and right-eye content and a synchronization signal indicative of the left-eye content being displayed on the display or the right-eye content being displayed on the display. Three-dimensional eyewear has a left-eye shutter disposed between the display and a left eye of a viewer and a right-eye shutter disposed between the display and a right eye of the viewer. Both of the shutters have an open mode, a closed mode and transition mode. Three-dimensional eyewear has a circuit that delays the transition mode of the left-eye shutter from the closed mode to the opened mode until the right-eye shutter is at least partially through the transition mode from the open mode to the closed mode and delays the transition mode of the right-eye shutter from the closed mode to the opened mode until the left-eye shutter is at least partially through the transition mode from the open mode to the closed mode.

In another embodiment, a method of synchronizing three-dimensional eyewear to a television is disclosed including alternately displaying left-eye content and right-eye content on a display of a television while sending a synchronization signal from the television to the eyewear. The synchronization signal is synchronized to the displaying of the left-eye content and the right-eye content on the display of the television. The synchronization signal is transmitted to the three-dimensional eyewear and starting of the opening of a left-eye shutter is delayed until after a period of time from when the right-eye shutter starts to close and starting of the opening of the right-eye shutter after the period of time from when the left-eye shutter starts to close.

In another embodiment, a three-dimensional eyewear synchronization system is disclosed including a display that alternately displays left-eye content and right-eye content. Three-dimensional eyewear have a left-eye shutter disposed between the display and a left eye of a viewer and a right-eye shutter disposed between the display and a right eye of the viewer. Both of the shutters have an open mode, a closed mode and transition mode. There is a device that synchronizes the shutters with the display that has provisions for delaying a transition of the left-eye shutter from the closed mode to the opened mode until the right-eye shutter is at least partially through the transition mode from the open mode to the closed mode and provisions for delaying a transition of the right-eye shutter from the closed mode to the opened mode until the left-eye shutter is at least partially through the transition mode from the open mode to the closed mode.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a television and directly connected three-dimensional eyewear.

FIG. 2 illustrates a plan view of a television and three-dimensional eyewear connected by radio frequencies.

FIG. 3 illustrates a plan view of a television and three-dimensional eyewear connected by wavelengths of light.

FIG. 4 illustrates a sequence of displayed frames as viewed according to a prior art of the prior art.

FIG. 5 illustrates a synchronization timing chart of the prior art.

FIG. 6 illustrates a schematic diagram of a three-dimensional eyewear with eyestrain relief.

FIG. 7 illustrates a waveform chart of a three-dimensional eyewear with eyestrain relief.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. Although the description shows a television as an example of a system to which the three-dimensional eyewear are synchronizing, any device including personal computers, electronic books, cellular phones and the like are anticipated.

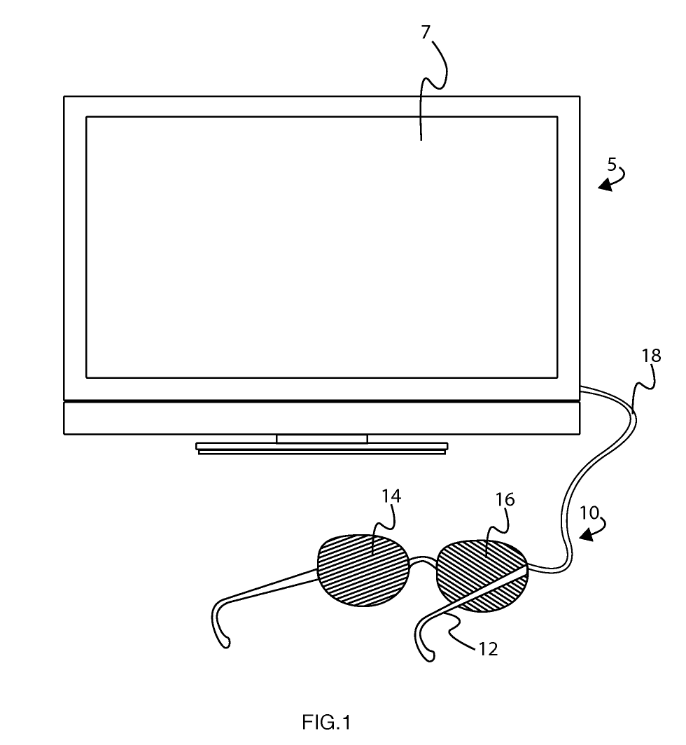

Referring to FIG. 1, a plan view of a television and three-dimensional eyewear connected by a cable or wire 18 is described. In some exemplary three-dimensional eyewear 10, a personal computer or specially equipped television 5 displays three-dimensional content on a display 7 and controls the eyewear 10 through a synchronization cable 18 to control eye shutters 14/16, synchronizing the eye shutters 14/16 to the content being displayed on the display 7. The eyewear 10 often includes frames with ear rests 12. The television 5 alternately displays left-eye content and right-eye content while the eyewear 10, synchronized to the television 5, opens the left-eye shutter 14 and closes the right-eye shutter 16 when the left-eye content is displayed and opens the right-eye shutter 16 and closes the left-eye shutter 14 when the right-eye content is displayed. This is done very quickly and the viewer does not perceive the open/close operations.

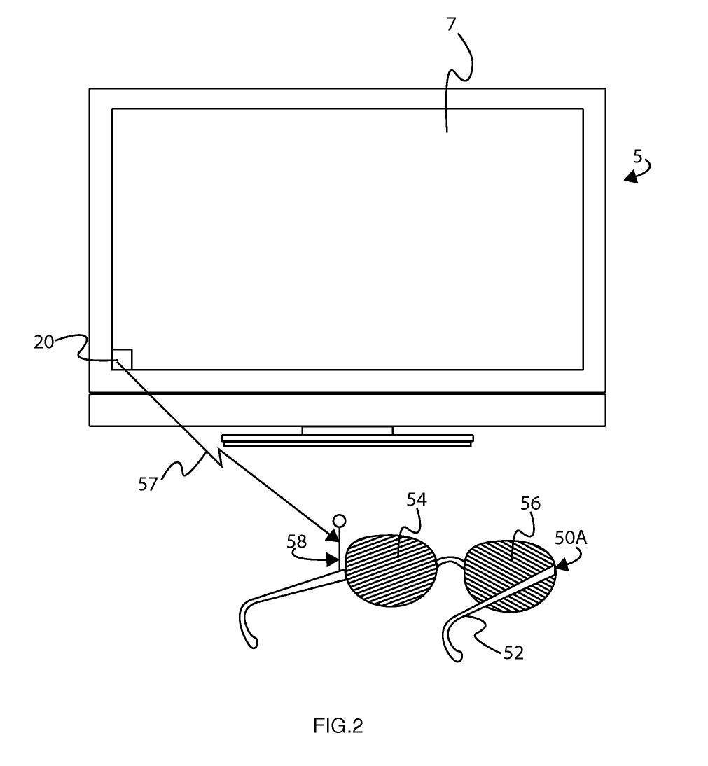

Referring to FIG. 2, a plan view of a display device (e.g. television) 5 interfaced with three-dimensional eyewear 50A connected by radio frequencies is described. In this, a transmitter device generates a synchronization signal that is transmitted to the three-dimensional eye wear 50A, in this example, by a radio frequency signal 57. For example, the synchronization signal is transmitted by a pre-determined frequency modulation, pulse code modulation, etc, as known in the industry. The radio frequency signal is received by an antenna 58 and decoded within the eyewear 50A or by an attached circuit to the eyewear 50A, controlling the eyewear shutters 54/56 as will be described. Note, in some embodiments, the eyewear 50A includes ear rests 52 for support. The television 5 alternately displays left-eye content and right-eye content while the eyewear 50A, synchronized to the television 5, opens the left-eye shutter 54 and closes the right-eye shutter 56 when the left-eye content is displayed and opens the right-eye shutter 56 and closes the left-eye shutter 54 when the right-eye content is displayed. This is done very quickly and the viewer does not perceive the open/close operations.

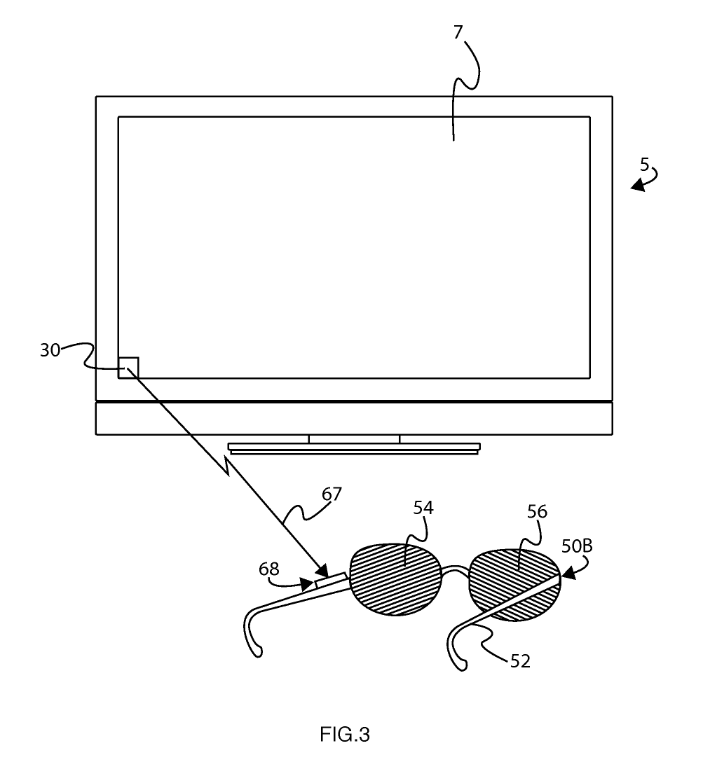

Referring to FIG. 3, a plan view of a television 5 interfaced with three-dimensional eyewear 50B by wavelengths of light is described. In this, a transmitter device 30 transmits a synchronization signal to the eye wear 50B, in this example, by a light signal 67. For example, the synchronization signal is transmitted by a pre-determined modulated wavelength of light 67, preferably non-visible light such as Infra-red light, etc, as known in the industry. The modulated light signal 67 is received by a light detector 68 and decoded within the eyewear 50B or by a circuit attached to the eyewear 50B, controlling the eyewear shutters 54/56 as will be described. Note, in some embodiments, the eyewear 50B includes ear rests 52 for support. The television 5 alternately displays left-eye content and right-eye content while the eyewear 50B, synchronized to the television 5, opens the left-eye shutter 54 and closes the right-eye shutter 56 when the left-eye content is displayed and opens the right-eye shutter 56 and closes the left-eye shutter 54 when the right-eye content is displayed. This is done very quickly and the viewer does not perceive the open/close operations.

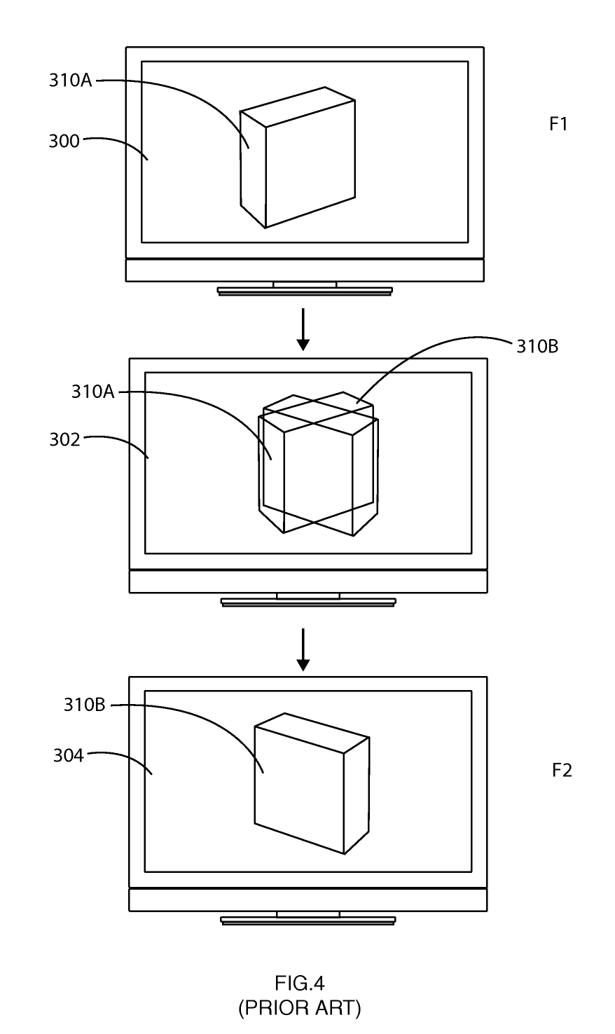

Referring to FIG. 4, a sequence of displayed frames as viewed according to a prior art is described. This is an exaggeration of what the left eye and the right eye sees from a three-dimensional perspective. As depicted, in three-dimensional perception, the left eye sees the left side of the box 310A and the right eye sees the right side of the box 310B. In a video transmission, the viewing angle would be much less than that in this exaggerated view. When the left frame F1 300 is displayed the left-eye shutter 14/54 is open and the right-eye shutter 16/56 is closed. When the right eye frame F2 304 is displayed, the right-eye shutter 16/56 is open and the left-eye shutter 14/54 is closed. A problem occurs due to the response time of the shutters 14/16/54/56 and associated driving circuits. The shutters 14/16/54/56 do not open and close instantaneously and there is a period of time when both the left-eye shutters 14/54 and the right-eye shutters 16/56 are open simultaneously as depicted in 302. For a very short time, the viewer sees the object from both perspectives 310A/310B at the same time. For example, when the synchronization signal indicates a transition from left-eye view to right-eye view, it takes several milliseconds for the left-eye shutter 14/54 to close and it takes several milliseconds for the right-eye shutter 16/56 to open, during which there is a period of time when both eye shutters 14/16/54/56 are partially open. Therefore, there is a short period of time that, while content on the display has switched from, say, a left-eye content frame 300 to a right-eye content frame 304, the left-eye shutter 14/54 remains at least partially open for a short time and the left eye sees the image F2 310B which is meant only for the right eye. Although the viewer sees this image, the user perception is not fast enough to make out the blurred or mixed image 302 and the user does not consciously perceive the presence of this image. Subliminally, the viewer's brain still receives this image and begins to analyze it until it is replaced by the correct, single eye image. This intermediate image 302 often leads to headaches and eyestrain of which viewers of three-dimensional often complain.

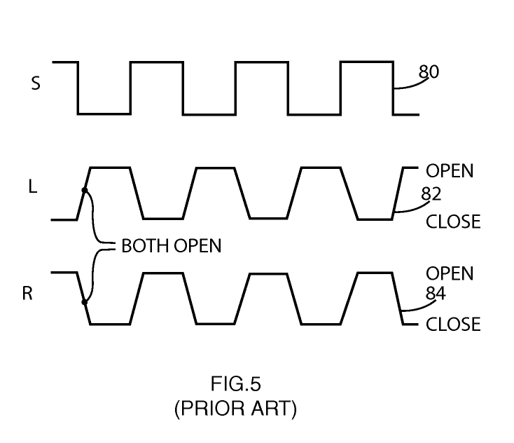

Referring to FIG. 5, an exemplary synchronization timing chart of the prior art is described. In this example, the alternation of the eye shutters 14/54/16/56 is intended to occur during the transitions of the synchronization signal 80, In essence, the left-eye shutter 14/54 is open (open mode) when the synchronization signal is at a low potential and the right-eye shutter 16/56 is open (open mode) when the synchronization signal is at a high potential.

The problem being addressed occurs, for example, as the synchronization signal 80 rises. The right-eye shutter 16/56 starts to open as depicted by the right-eye shutter waveform 84 while the left-eye shutter 14/54 starts to close (close mode) as depicted by the left-eye shutter waveform 82. Due to the response time of the shutters 14/54/16/56, the slope of both transitions of the left shutter and right shutter waveforms 82/84 is sloped (transition mode). Due to the response time depicted by the slope of the left shutter and right shutter waveforms 82/84, the right-eye shutter 16/56 slowly opens and the left-eye shutter 14/54 slowly closes, during this transition, both the right-eye shutter 14/54 and the left-eye shutter 16/56 are concurrently open, at least partially open, allowing both eyes to see the same perspective. For example, during the leading transition of the synchronization signal, the displayed content has already changed to right-eye content on the television 5, but the left-eye shutter 14/54 remains open for a short interval, allowing the left eye to see the right-eye content, at least partially, for that interval. This is believed to cause eyestrain, fatigue and headaches.

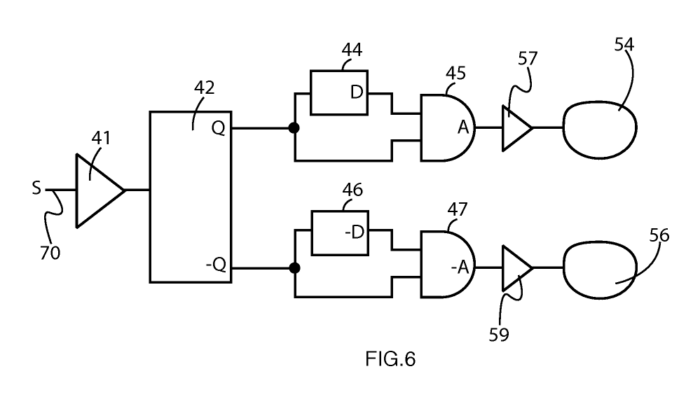

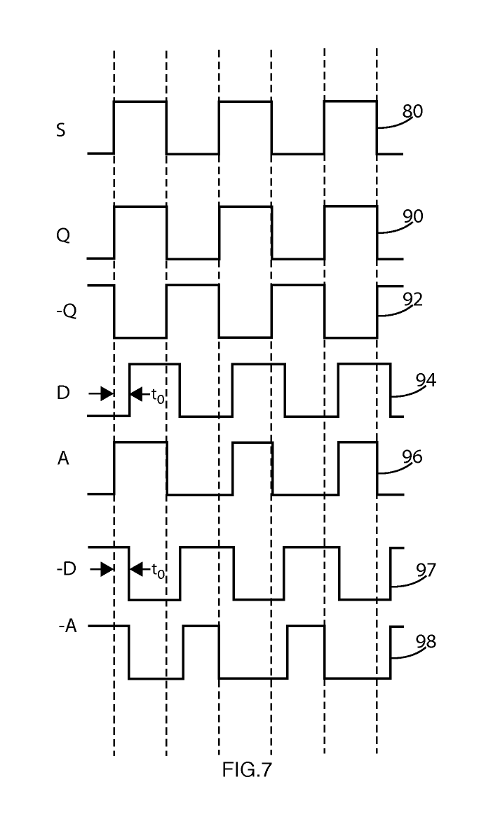

Referring to FIGS. 6 and 7, a schematic diagram and waveform chart of a three-dimensional eyewear 10/50A/50B with eyestrain relief is described. In this exemplary circuit, the synchronization signal 70 is optionally amplified by an amplifier 41 and coupled to a timing circuit 42 that translates the synchronization signal 70 into a left-eye (Q) control signal and a right-eye (−Q). In some embodiments, the timing circuit 42 includes a phased-locked-loop that provides the left-eye and right-eye control signal during a loss of the synchronization signal 70. Each output (Q, −Q) is coupled to a delay circuit 44/46 and is “anded” with an output of the delay circuit (D, −D) by and-gates 45/47 to generate a left-eye shutter signal (A) and a right-eye shutter signal (−A) that is interfaced to the left-eye shutter 14/54 and right-eye shutter 16/56, respectively, by shutter drivers 57/59. In this way, opening of the left-eye shutter 14/54 is delayed by the delay circuit 44 long enough for the right-eye shutter 16/56 to close. Likewise, opening of the right-eye shutter 16/56 is delayed by the delay circuit 46 long enough for the left-eye shutter 14/54 to close.

Referring to FIG. 7, the alternation of the eye shutters 14/54/16/56 is intended to occur during the transitions of the synchronization signal 80. In this example, the left-eye shutter 14/54 is open when the synchronization signal is high and the right-eye shutter 16/56 is open when the synchronization signal is low. As the synchronization signal 80 rises, the timing circuit sets Q 90 and resets −Q 92. The Q output 90 drives the left delay circuit 44 and the delayed Q signal appears at the output, D 94, of the left delay circuit 44. Likewise, the −Q output 92 drives the right delay circuit 46 and the delayed −Q signal 97 appears at the output, −D, of the left delay circuit 46. The Q output 90 and the delayed Q output D 94 are “anded” by a gate 45, producing the left driver signal A 96. The −Q output 92 and the delayed −Q output (−D) 97 are “anded” by a gate 47, producing the right driver signal −A 98.

The left-eye shutter 14/54 is driven by the left driver signal 96 and the right-eye shutter 16/56 is driven by the right driver signal 98. For example, a circuit as this results in a trailing edge of the right-eye shutter driver signal 98, then after a delay of t₀, a leading edge of the left-eye shutter driver signal 96, etc. Therefore, the right-eye shutter 16/56 at least partially shuts off (closes) before the left-eye shutter 14/54 starts to turn on (opens).

It is anticipated that either the transitions of the synchronization signal 80 precede the alteration of left-eye frames and right-eye frames on the television 5 by t₀ (or less than t₀) or the alteration of left-eye frames and right-eye frames on the television 5 are delayed by t₀ (or less than t₀). For example, at the time of the leading edge of the synchronization signal 80, the left-eye content is displayed on the television for approximately t₀ after the transition before changing to right-eye content, thereby not displaying right-eye content until the left-eye shutter 14/54 is fully closed, etc.

It is anticipated that the delay t₀ is any delay up to, for example, the half-cycle period of the synchronization signal 80. For example, for shutters 14/54/16/56 that have a response time of 1 millisecond, it is anticipated that one delay t₀ is 1 millisecond. As another example, for shutters 14/54/16/56 that have a response time of 1 millisecond, it is anticipated that one delay t₀ is 500 microseconds, allowing the closing shutter 14/54/16/56 enough time to close to approximately half way before starting to open the opening shutter 14/54/16/56.

Equivalent elements can be substituted for the ones set forth above such that they perform in substantially the same manner in substantially the same way for achieving substantially the same result.

It is believed that the system and method and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A three-dimensional synchronization system comprising:
a display, the display alternately displaying left-eye content and right-eye content;
a synchronization signal indicative of the left-eye content displayed on the display and the right-eye content displayed on the display; and
three-dimensional eyewear having a left-eye shutter disposed between the display and a left eye of a viewer and a right-eye shutter disposed between the display and a right eye of the viewer; both of the shutters having an open mode, a closed mode and transition mode, a circuit delays the transition mode of the left-eye shutter from the closed mode to the opened mode until the right-eye shutter is at least partially through the transition mode from the open mode to the closed mode, the circuit also delays the transition mode of the right-eye shutter from the closed mode to the opened mode until the left-eye shutter is at least partially through the transition mode from the open mode to the closed mode.

2. The three-dimensional synchronization system of claim 1, wherein the circuit delays for a time interval that is approximately equal to a response time of the shutters.

3. The three-dimensional synchronization system of claim 1, wherein the circuit delays for a time interval that is approximately equal to half of a response time of the shutters.

4. The three-dimensional synchronization system of claim 1, wherein timing of the alternately displaying the left-eye content and the right-eye content is also delayed by a time interval.

5. The three-dimensional synchronization system of claim 2, wherein timing of the alternately displaying the left-eye content and the right-eye content is also delayed by the time interval.

6. The three-dimensional synchronization system of claim 3, wherein timing of the alternately displaying the left-eye content and the right-eye content is also delayed by the time interval.

7. A method of synchronizing three-dimensional eyewear to a television, the method comprising:
alternately displaying left-eye content and right-eye content on a display of a television;
sending a synchronization signal from the television to the eyewear, the synchronization signal synchronized to the displaying of the left-eye content and the right-eye content on the display of the television;
transmitting the synchronization signal to the three-dimensional eyewear;
starting opening of a left-eye shutter after a period of time from when the right-eye shutter starts to close; and
starting opening of the right-eye shutter after the period of time from when the left-eye shutter starts to close.

8. The method of claim 7, wherein delay is approximately equal to a response time of the shutters.

9. The method of claim 7, wherein the delay is approximately equal to half of a response time of the shutters.

10. The method of claim 7, further comprising the step of delaying the display of the left-eye content by the delay and delaying the display of the right-eye content by the delay.

11. A three-dimensional synchronization system comprising:
a display, the display alternately displaying left-eye content and right-eye content;
three-dimensional eyewear having a left-eye shutter disposed between the display and a left eye of a viewer and a right-eye shutter disposed between the display and a right eye of the viewer; both of the shutters having an open mode, a closed mode and transition mode;
a means for synchronizing the shutters with the display;
a means for delaying a transition of the left-eye shutter from the closed mode to the opened mode until the right-eye shutter is at least partially through the transition mode from the open mode to the closed mode; and
a means for delaying a transition of the right-eye shutter from the closed mode to the opened mode until the left-eye shutter is at least partially through the transition mode from the open mode to the closed mode.

12. The three-dimensional synchronization system of claim 11, wherein the means for delaying the transition of the left-eye shutter and the means for delaying the transition of the right-eye shutter delays the transition by a time interval.

13. The three-dimensional synchronization system of claim 12, wherein the time interval is approximately equal to a response time of the shutters.

14. The three-dimensional synchronization system of claim 12, wherein the time interval is approximately equal to half of a response time of the shutters.

15. The three-dimensional synchronization system of claim 11, wherein timing of the alternately displaying the left-eye content and the right-eye content is delayed by a time interval.

16. The three-dimensional synchronization system of claim 15, wherein the time interval is at least partially through the transition mode.

17. The three-dimensional synchronization system of claim 15, wherein the time interval is approximately equal to half of a response time of the shutters.
